(19) United States
(12) Patent Application Publication
(10) Pub. No.: US 2026/0254320 A1
(43) Pub. Date: Aug. 27, 2026

(54) Electric Drive Device and Method for Controlling Electric Drive Device

(71) Applicant: Astemo, Ltd., Chiyoda-ku, Tokyo (JP)

(72) Inventors: Takaki ITAYA, Hitachinaka-shi, Ibaraki (JP); Noriyuki MAEKAWA, Hitachinaka-shi, Ibaraki (JP)

(21) Appl. No.: 19/162,438

(22) PCT Filed: Jun. 5, 2023
(86) PCT No.: PCT/JP2023/020853

§ 371 Date: Sep. 5, 2025

(51) Int. Cl. H02K 9/19

(52) U.S. Cl. CPC H02K 9/19

(57) ABSTRACT

An electric drive device that, in a vehicle including a motor having a rotor and a stator, and a refrigerant channel through which refrigerant for cooling the motor flows, drives the motor by a battery and charges the battery using the motor. The electric drive device includes a flow volume adjusting unit that adjusts a flow volume of the refrigerant to be supplied to the rotor and the stator. In a case in which the battery is charged by applying electricity to a coil of the stator while the vehicle is stopped, the flow volume adjusting unit switches the flow volume of the refrigerant to be supplied to the rotor and the stator, such that the flow volume of the refrigerant supplied to the stator increases as compared to a case in which the battery is charged without applying electricity to the coil of the stator.

### TECHNICAL FIELD

The present invention relates to an electric drive device and a method for controlling the electric drive device.

### BACKGROUND ART

In order to shorten battery charging time of stopped vehicles, battery charging voltage needs to be high voltage.

In a case in which two types of voltages, which are 400 V and 800 V for example, coexist as charging-facility voltage and battery voltage, charging a battery having 800 V specifications by charging-facilities of 400 V specifications requires boosting from 400 V to 800 V. Accordingly, charging time can be shortened by utilizing a rapid charging system using a boosting chopper circuit that uses a three-phase line of a traction motor equipped in the vehicle. However, in a case of using the rapid charging system, the amount of heat generated by the motor increases, and thus there is need to increase a flow volume of refrigerant that is supplied to the motor.

In a case of increasing the flow volume of refrigerant that is supplied to the motor, control is performed to raise liquid level height of the refrigerant in the motor, for example, and with respect to this raising of the liquid level, PTL 1 below, for example, discloses a configuration of a control device of a vehicle that raises an oil level height in the motor when performing deceleration-traveling, regardless of a state of charge of a rechargeable battery.

### CITATION LIST

### Patent Literature

[PTL 1] Japanese Patent Application Publication No. 2018-152946

### SUMMARY OF INVENTION

### Technical Problem

In light of the technology disclosed in PTL 1, during rapid charging of a battery in a stopped vehicle, there is a need to raise liquid level of coolant oil in the motor to prevent temperature of a stator coil from rising due to charging using the motor, such that burnout of the stator coil does not occur. In light of this, it is an object of the present invention to provide an electric drive device and a method for controlling the electric drive device that improve cooling capabilities of a stator coil during rapid charging of the battery.

### Solution to Problem

An electric drive device and a method for controlling the electric drive device that, in a vehicle including a motor having a rotor and a stator, and a refrigerant channel through which refrigerant for cooling the motor flows, drives the motor by a battery and charges the battery using the motor, the electric drive device including a flow volume adjusting unit that adjusts a flow volume of the refrigerant to be supplied to the rotor and the stator, wherein in a case in which the battery is charged by applying electricity to a coil of the stator while the vehicle is stopped, the flow volume adjusting unit switches the flow volume of the refrigerant to be supplied to the rotor and the stator, such that the flow volume of the refrigerant supplied to the stator increases as compared to a case in which the battery is charged without applying electricity to the coil of the stator.

### Advantageous Effects of Invention

According to the present invention, an electric drive device and a method for controlling the electric drive device can be provided that improve reliability of a motor during rapid charging of a battery.

### BRIEF DESCRIPTION OF DRAWINGS

FIG. 1 is an explanatory diagram of an electric drive device according to an embodiment of the present invention.

FIG. 2 is a control flow of the electric drive device in FIG. 1.

FIG. 3 is a modification of FIG. 1.

FIG. 4 is a diagram for describing a cooling oil level within a motor being controlled, according to the embodiment of the present invention.

FIG. 5 is a control flow of the electric drive device in FIG. 4.

### DESCRIPTION OF EMBODIMENTS

An embodiment of the present invention will be described below with reference to the drawings. The following description and drawings are exemplifications for describing the present embodiment, without omissions and simplifications being made as appropriate to clarify the description. The present invention can be carried out in various other forms.

The components may be singular or may be plural, unless limited in particular.

The positions, sizes, shapes, ranges, and so forth of the components illustrated in the drawings may not indicate actual positions, sizes, shapes, ranges, and so forth, for the sake of facilitating understanding of the invention.

Accordingly, the present invention is not necessarily limited to positions, sizes, shapes, ranges, and so forth, disclosed in the drawings.

### Embodiment and Overall Configuration

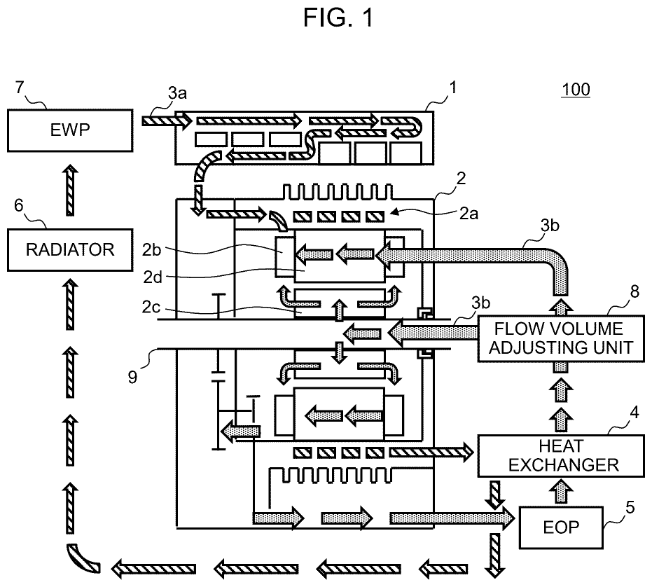

### FIG. 1

An electric drive device 100 used in the present invention is installed in a vehicle such as an electric vehicle or the like, and a motor 2 is driven by a battery. In a case of charging this battery, charging is performed using the motor 2 in order to shorten charging time while the vehicle is stopped. Specifically, the electric drive device 100 receives electric power from charging facilities such as, for example, a commercial alternating current power source or the like, and charges a high-voltage battery that is installed in the vehicle, thereby obtaining drive electric power for the vehicle while the vehicle is stopped. At this time, the electric drive device 100 boosts the voltage by a boosting chopper circuit that uses a three-phase line of the motor 2, in order to perform charging of the battery that is of higher voltage than the voltage of the charging facilities. This enables rapid charging of the battery of the vehicle that is stopped. The boosting chopper circuit is made up of, for example, choke coils, switching circuits, and diodes.

The electric drive device 100 also controls flow of refrigerant flowing to the electric devices that the vehicle is equipped with. The motor 2 that has an inverter 1, a rotor 2c, and a stator 2d is cooled by a refrigerant channel through which coolant water 3a flows, and a refrigerant channel through which coolant oil 3b flows. The coolant water 3a circulates through and cools the inverter 1 and the motor 2.

Cooling of the inverter 1 and the motor 2 by the coolant water 3a will be described. An EWP 7 (Electric Water Pump: electric water pump) cools the inverter 1 by supplying the coolant water 3a to the inverter 1. Next, the coolant water 3a is supplied from the inverter 1 to the motor 2, and at the motor 2, cools the entire motor 2 by flowing through a jacket 2a provided on an inner peripheral side of the motor 2, for example.

The coolant water 3a that has cooled the motor 2 is supplied to a heat exchanger 4, and indirectly cools the coolant oil 3b via the heat exchanger 4 in the same way. The coolant water 3a is fed from the heat exchanger 4 to a radiator 6, and is cooled by the radiator 6 to a temperature at which the devices can be appropriately cooled, from a state of holding heat absorbed from the motor 2 and heat absorbed from the coolant oil 3b. The coolant water 3a is fed from the radiator 6 to the EWP 7. This completes a circulation cycle of the coolant water 3a in the vehicle.

Next, cooling of the coolant oil 3b to the motor 2 will be described. In a case of performing rapid charging when the vehicle is stopped, a boosting circuit that uses a three-phase line of the motor is used, but cooling of the stator 2d that has the stator coil 2b that generates a great amount of heat at this time needs to be intensified.

Accordingly, the amount of refrigerant supplied to the rotor 2c is reduced, and the amount of refrigerant supplied to the stator 2d is increased by a corresponding amount, as an increase in amount of refrigerant supplied to the stator 2d, thereby intensifying the cooling of the stator 2d.

A specific flow of refrigerant, of the coolant oil 3b, will be described. An EOP 5 (Electric Oil Pump: electric oil pump) supplies the coolant oil 3b to a flow volume adjusting unit 8 via the heat exchanger 4. In a case of determining that the vehicle has stopped and rapid charging of the battery has started, from an instruction from a higher-order control device or the like that is omitted from illustration, for example, the flow volume adjusting unit 8 adjusts and switches over the flow volume of refrigerant to be supplied to the rotor 2c and the stator 2d in the motor 2.

Specifically, the flow volume adjusting unit 8 switches the supply amount so as to reduce the supply amount of the coolant oil 3b to be supplied to the rotor 2c via a shaft 9, and increase the supply amount of the coolant oil 3b to the stator 2d that has the stator coil 2b.

Accordingly, the flow volume of the refrigerant supplied to the stator 2d including a stator core and the stator coil 2b increases in comparison with a case in which the battery is charged without applying electricity to the stator coil 2b. Thus, cooling of the stator of which heat generation amount increases during rapid charging can be performed alongside with boosting of voltage in conjunction with charging the battery of the vehicle, while the vehicle is stopped. Also, the stator coil 2b can be directly cooled with the coolant oil 3b. Further, burnout of the stator coil 2b during rapid charging of the battery can be prevented from occurring.

Note that determination regarding switching of the flow volume of the coolant oil 3b to the rotor 2c and the stator 2d at the flow volume adjusting unit 8 is made on the basis of an unshown temperature sensor or the like that detects the temperature of the stator 2d of the motor 2, for example, and can be realized by increasing the flow volume of the coolant oil 3b to be supplied to the stator 2d and also reducing the flow volume of the coolant oil 3b supplied to the rotor 2c, in a case in which the temperature is greater than a predetermined threshold value or is judged to have exceeded the threshold value by a reference that predicts exceeding the predetermined threshold value.

The coolant oil 3b that has cooled the rotor 2c and the stator 2d returns to the EOP 5. By passing through the heat exchanger 4 in a case of supplying the coolant oil 3b from the EOP 5 to the motor 2 again, the heat of the coolant oil 3b is indirectly dissipated to the coolant water 3a passing through the heat exchanger 4 in the same way, whereby the temperature of the coolant oil 3b can be returned to a temperature that is capable of appropriately cooling the motor 2.

Note that description is being made assuming that out of a first channel through which the coolant water 3a flows, and a second channel through which the coolant oil 3b flows, the first channel through which the coolant water 3a flows is made to flow first, in order to cool the motor 2 and to cool the coolant oil 3b at the heat exchanger 4 at the same time, but this is not limiting, and either channel can be made to flow first.

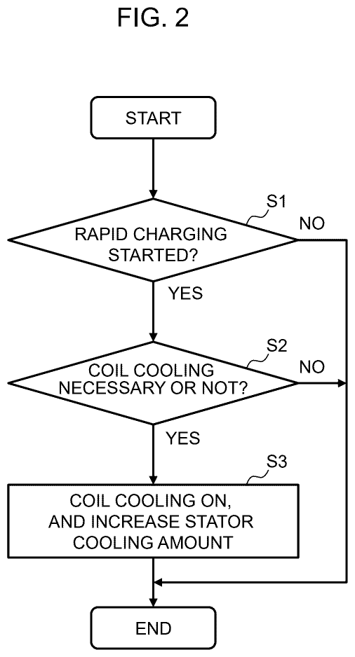

### FIG. 2

A control flow of the refrigerant flow volume of the electric drive device 100 according to the present invention will be described. In step S1, determination is made regarding whether or not rapid charging of the vehicle has been started, and in a case in which rapid charging of the vehicle is determined to have been started, the flow advances to step S2. In a case in which rapid charging is not started, the flow ends.

In step S2, whether or not cooling of the stator coil 2b in conjunction with starting of the rapid charging is necessary is determined, and in a case of determining that cooling of the stator coil 2b during the rapid charging is necessary, the flow advances to step S3. In a case in which this is unnecessary, the flow ends.

In step S3, the cooling amount of the stator 2d that has the stator coil 2b is increased in order to directly cool the stator coil 2b by the coolant oil 3b, and the flow ends.

Thus, not only is the cooling amount of the stator 2d during rapid charging increased, but the cooling amount of the rotor 2c is reduced, thereby suppressing unnecessary driving of the oil pump and water pump, and electric power consumption of the battery can be suppressed.

### Modification

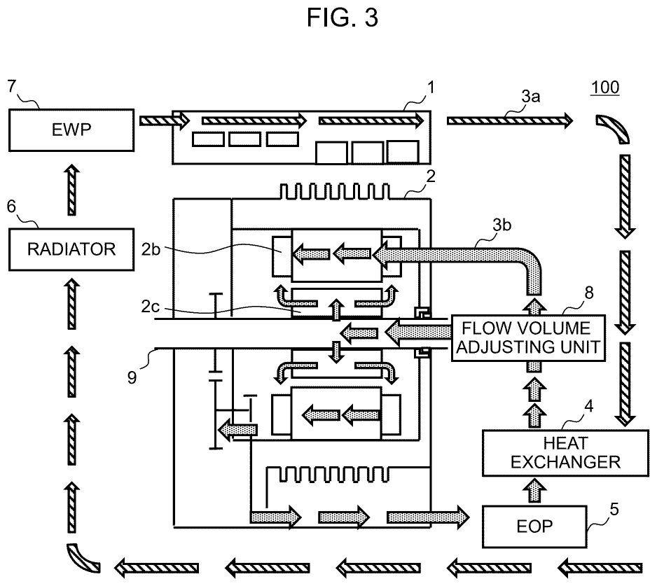

### FIG. 3

The present invention can also be applied to a case of cooling the motor 2 by the coolant oil 3b alone, without using the coolant water 3a. In this case, the coolant water 3a cools the inverter 1 via the radiator 6 and the EWP 7, but does not pass through the motor 2, and circulates through and cools other electric devices that are not illustrated. Meanwhile, the flow of the coolant oil 3b that cools the motor 2 is the same as in FIG. 1. In this arrangement as well, the coolant oil 3b is indirectly cooled by the coolant water 3a via the heat exchanger 4 and thus can be lowered to a temperature where the motor 2 can be appropriately cooled, and sufficient cooling can be performed even without the coolant water 3a flowing through the motor 2, and accordingly burnout of the stator coil 2b during rapid charging can be prevented.

Note that when cooling the motor 2 by oil cooling by the coolant oil 3b alone, circulation of the coolant oil 3b may be started after starting circulation of the coolant water 3a to the heat exchanger 4, or circulation of the coolant water 3a may be started after starting circulation of the coolant oil 3b, or both may be started at the same time.

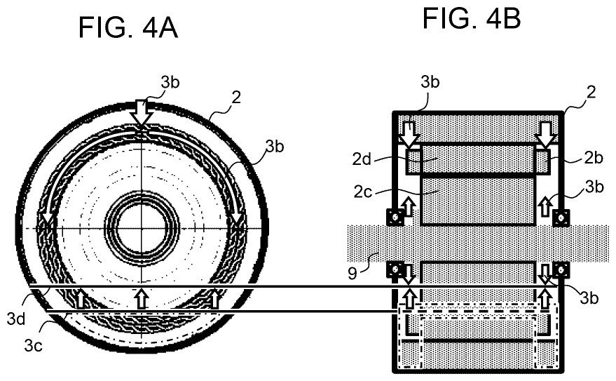

### FIG. 4

FIG. 4(a) is a radial-direction cross-sectional view of the motor 2, illustrating the way in which liquid level inside the motor rises, and FIG. 4(b) is an axial-direction cross-sectional view of FIG. 4(a). In the motor 2, the vehicle is stopped for rapid charging, and rotation of the rotor 2c is also stopped. When the rotor 2c is rotated in a state in which the coolant oil 3b is present in the motor 2, there is a risk of the coolant oil 3b intruding into a gap between the stator 2d and the rotor 2c. Accordingly, in order to prevent intrusion of the coolant oil 3b into the gap portion, the vehicle has a structure in which transmission of driving force is interrupted, such that motive power for traveling is not transmitted to a traction shaft (driveshaft). Accordingly, raising the liquid level of the coolant oil 3b in the motor 2 can be safely realized, and also the coolant oil 3b can be circulated to the motor 2 by rotation of the rotor 2c following the rapid charging, whereby thermal transfer among the coolant oil 3b, the rotor 2c, and the stator 2d can be promoted.

In a case in which further cooling of the stator 2d is necessary, the flow volume adjusting unit 8 (FIG. 1) performs oil cooling of the stator 2d, and further increases the coolant oil 3b that comes into direct contact with the stator coil 2b from a liquid level 3c to a liquid level 3d. Accordingly, the cooling efficiency of the stator 2d is raised.

With respect to the stator coil 2b that becomes hot during rapid charging, the temperature of the stator coil 2b is detected by, for example, a sensor or the like that is omitted from illustration. In a case in which the temperature change per time unit is higher than a predetermined reference in this detected temperature, determination is made that appropriate cooling is insufficient, and determination is made to raise the liquid level height of the coolant oil 3b within the motor 2. Thus, the height of the liquid level within the motor 2 is raised, whereby cooling of the motor 2 during rapid charging can be improved.

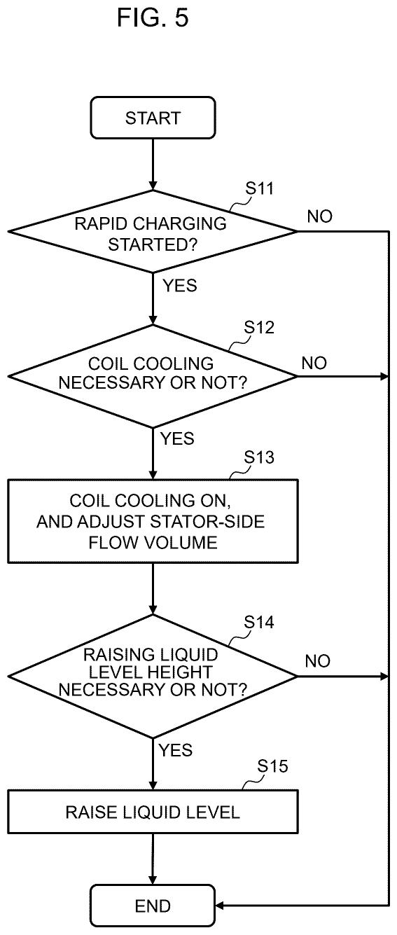

### FIG. 5

A control flow of the electric drive device 100 according to the present invention in FIG. 4 will be described. In step S11, the electric drive device 100 determines regarding whether or not rapid charging of the vehicle has been started, and in a case in which rapid charging is determined to have been started, the flow advances to step S12. In a case in which rapid charging is not started, the flow ends.

In step S12, whether or not cooling of the stator coil 2b during rapid charging is necessary is determined, and in a case of determining that cooling thereof is necessary, the flow advances to step S13. In step S13, the flow volume of the coolant oil 3b supplied to the stator 2d is increased in order to perform direct cooling of the stator coil 2b by the coolant oil 3b.

In step S14, determination is made regarding whether or not raising the height of the liquid level of the coolant oil 3b within the motor 2 is necessary. If raising the height of the liquid level within the motor 2 is unnecessary, the flow ends. In a case of determining that raising the height of the liquid level within the motor 2 is necessary, the liquid level of the coolant oil 3b within the motor 2 is further raised in step S15, and the flow ends.

While cooling the motor 2 and the inverter 1 by water cooling and oil cooling has been described above in the present invention, cooling of the inverter 1 and the motor 2 by water cooling alone may be realized.

According to the embodiment of the present invention described above, the following operations and advantages can be yielded.
(1) An electric drive device that, in a vehicle including a motor 2 having a rotor 2c and a stator, and a refrigerant channel through which refrigerant for cooling the motor 2 flows, drives the motor 2 by a battery and charges the battery using the motor 2, the electric drive device including a flow volume adjusting unit 8 that adjusts a flow volume of the refrigerant to be supplied to the rotor 2c and the stator. In a case in which the battery is charged by applying electricity to a coil 2b of the stator while the vehicle is stopped, the flow volume adjusting unit 8 switches the flow volume of the refrigerant to be supplied to the rotor 2c and the stator, such that the flow volume of the refrigerant supplied to the stator increases as compared to a case in which the battery is charged without applying electricity to the coil 2b of the stator. Thus, the electric drive device 100 can be provided that improves reliability of the motor 2 at the time of rapid charging of the battery.
(2) Further included is a temperature sensor that detects a temperature of the stator where, in a case in which the temperature of the stator detected by the temperature sensor is greater than a predetermined threshold value, the flow volume adjusting unit 8 increases the flow volume of the refrigerant to be supplied to the stator. Thus, burnout of the stator coil 2b during rapid charging of the battery can be prevented from occurring.
(3) Further included is a temperature sensor that detects a temperature of the stator where, in a case in which the temperature of the stator detected by the temperature sensor is greater than a predetermined threshold value, the flow volume adjusting unit 8 reduces the flow volume of the refrigerant to be supplied to the rotor 2c. Thus, burnout of the stator coil 2b during rapid charging of the battery can be prevented from occurring.
(4) The flow volume adjusting unit 8 switches the flow volume of the refrigerant to be supplied to the rotor 2c and the stator, such that a filling height of the refrigerant in the motor 2 is higher. Thus, further cooling of the stator coil 2b can be handled.
(5) The refrigerant includes coolant water 3a and coolant oil 3b, and the coolant water 3a is made to flow through a refrigerant channel formed on a further outer peripheral side than the stator. Thus, burnout of the stator coil 2b can be prevented from occurring in a case of cooling the motor 2 by water cooling alone, for example.
(6) The refrigerant includes coolant water 3a and coolant oil 3b, and the electric drive device includes a first channel through which the coolant water 3a for cooling the motor 2 and an electrical device other than the motor 2, and a second channel through which the coolant oil 3b for cooling the motor 2 flows. At this time, one of the coolant water 3a to flow through the first channel, and the coolant oil 3b to flow through the second channel, is made to flow first. Thus, cooling of the motor 2 during rapid charging is contributed to, regardless of which channel is given priority.
(7) The refrigerant includes coolant water 3a and coolant oil 3b, and the electric drive device includes a first channel through which the coolant water 3a for cooling the motor 2 and an electrical device other than the motor 2, and a second channel through which the coolant oil 3b for cooling the motor 2 flows. The coolant water 3a to flow through the first channel is made to flow first before the coolant oil 3b to flow through the second channel. Thus, even when the second channel is given priority over the first channel, cooling of the motor 2 during rapid charging can be contributed to.
(8) A method for controlling an electric drive device that, in a vehicle that cools a motor 2 having a rotor 2c and a stator by refrigerant, uses a battery for charging and driving of the motor 2, the method including, in a case in which the battery is charged by applying electricity to a coil of the stator while the vehicle is stopped, switching a flow volume of the refrigerant to be supplied to the rotor 2c and the stator, such that the flow volume of the refrigerant supplied to the stator increases as compared to a case in which the battery is charged without applying electricity to the stator coil 2b. Employing such a control method enables improved reliability of the motor 2 at the time of rapid charging of the battery to be realized.

Note that the present invention is not limited to the above embodiment, and that various other modifications and other configurations can be combined without departing from the spirit thereof. Also, the present invention is not limited to arrangements that include all configurations described in the embodiment above, and also includes arrangements in which part of the configurations are omitted.

### REFERENCE SIGNS LIST

1 Inverter
2 Motor
2a Jacket
2b Stator coil
2c Rotor
2d Stator
3 Refrigerant
3a Coolant water
3b Coolant oil
30 Liquid level height
3d Liquid level height following rising
4 Heat exchanger
5 EOP
6 Radiator
7 EWP
8 Flow volume adjusting unit
9 Shaft
100 Electric drive device

1. An electric drive device that, in a vehicle including a motor having a rotor and a stator and a refrigerant channel through which refrigerant for cooling the motor flows, drives the motor by a battery and charges the battery using the motor, the electric drive device comprising:
a flow volume adjusting unit that adjusts a flow volume of the refrigerant to be supplied to the rotor and the stator, wherein
in a case in which the battery is charged by applying electricity to a coil of the stator while the vehicle is stopped, the flow volume adjusting unit switches the flow volume of the refrigerant to be supplied to the rotor and the stator, such that the flow volume of the refrigerant supplied to the stator increases as compared to a case in which the battery is charged without applying electricity to the coil of the stator.

2. The electric drive device according to claim 1, further comprising:
a temperature sensor that detects a temperature of the stator, wherein
in a case in which the temperature of the stator detected by the temperature sensor is greater than a predetermined threshold value, the flow volume adjusting unit increases the flow volume of the refrigerant to be supplied to the stator.

3. The electric drive device according to claim 1, further comprising:
a temperature sensor that detects a temperature of the stator, wherein
in a case in which the temperature of the stator detected by the temperature sensor is greater than a predetermined threshold value, the flow volume adjusting unit reduces the flow volume of the refrigerant to be supplied to the rotor.

4. The electric drive device according to claim 1, wherein
the flow volume adjusting unit switches the flow volume of the refrigerant to be supplied to the rotor and the stator, such that a filling height of the refrigerant in the motor is higher.

5. The electric drive device according to claim 1, wherein
the refrigerant includes coolant water and coolant oil, and
the coolant water is made to flow through a refrigerant channel formed on a further outer peripheral side than the stator.

6. The electric drive device according to claim 1, wherein the refrigerant includes coolant water and coolant oil, the electric drive device further comprising a first channel through which the coolant water for cooling the motor and an electrical device other than the motor, and a second channel through which the coolant oil for cooling the motor flows, wherein
one of the coolant water to flow through the first channel, and the coolant oil to flow through the second channel, is made to flow first.

7. The electric drive device according to claim 1, wherein
the refrigerant includes coolant water and coolant oil,
the electric drive device further comprising a first channel through which the coolant water for cooling the motor and an electrical device other than the motor, and a second channel through which the coolant oil for cooling the motor flows, wherein the coolant water to flow through the first channel is made to flow first before the coolant oil to flow through the second channel.

8. A method for controlling an electric drive device that, in a vehicle that cools a motor having a rotor and a stator by refrigerant, uses a battery for charging and driving of the motor, the method comprising:
in a case in which the battery is charged by applying electricity to a coil of the stator while the vehicle is stopped, switching a flow volume of the refrigerant to be supplied to the rotor and the stator, such that the flow volume of the refrigerant supplied to the stator increases as compared to a case in which the battery is charged without applying electricity to the coil of the stator.
